(19) United States
(12) Patent Application Publication
(10) Pub. No.: US 2025/0323282 A1
(43) Pub. Date: Oct. 16, 2025

(54) HIGH SURFACE AREA PLATING FOR OXYGEN EVOLUTION ELECTRODES

(71) Applicant: FORM ENERGY, INC., Somerville, MA (US)

(72) Inventors: Anthony Edwards SULLIVAN, Reading, MA (US); Jeremy HITT, Charlestown, MA (US); Muhammad NASIR, Revere, MA (US); Anne Katherine HICKEY, Cambridge, MA (US); Daniel Louis BECERRA, Pittsburgh, PA (US); Zachary Dean KAUFMAN, Pittsburgh, PA (US)

(21) Appl. No.: 19/177,086

(22) Filed: Apr. 11, 2025

Related U.S. Application Data
(60) Provisional application No. 63/632,934, filed on Apr. 11, 2024.

(51) Int. Cl. H01M 4/88; H01M 4/90; H01M 12/06

(52) U.S. Cl. CPC H01M 4/8853; H01M 4/9041; H01M 12/06

(57) ABSTRACT

Oxygen evolution electrodes having high surface area plating and methods of forming such oxygen evolution electrodes are described. According to one aspect, an electrode for an oxygen evolution reaction (OER) may include a substrate including at least one surface and a layer of nickel coated on the at least one surface of the substrate. The at least one surface of the substrate has a first surface area, the layer of nickel has a second surface area, and a ratio of the second surface area to the first surface area is greater than about 10:1 and less than about 50:1.

### CROSS-REFERENCE TO RELATED APPLICATIONS

This application claims the benefit of priority to U.S. Provisional Patent Application 63/632,934, filed Apr. 11, 2024, the entire contents of which are hereby incorporated by reference herein.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8h) energy storage systems. Of benefit are potentially low-cost rechargeable battery chemistries that can enable long duration large scale energy storage.

### SUMMARY

According to one aspect, a method of making an oxygen evolution electrode for a metal-air battery may include at least partially immersing a cathode and an anode in a solution, the solution including cations of a metal, applying electric current between the cathode and the anode in the solution, the electric current generating bubbles on at least one surface of a substrate of the cathode as the cations of the metal chemically reduce around the bubbles on the at least one surface of the substrate and form a layer of the metal on the at least one surface of the substrate and, with the layer formed on the surface of the substrate, removing the substrate from the solution.

In some implementations, the solution may further include ammonium cations.

In certain implementations, the solution may be an aqueous solution, and the bubbles on the at least one surface of the substrate are hydrogen. For example, at least partially immersing the cathode and the anode in the solution includes dissolving a metal salt in water. As a specific example, the metal salt includes a nickel salt (e.g., nickel chloride), and the layer formed on the at least one surface of the substrate of the cathode includes nickel. In some instances, at least partially immersing the cathode and the anode in the solution may include dissolving ammonium chloride in the aqueous solution. Further, or instead, at least partially immersing the cathode and the anode in the solution may include dissolving ammonium sulfamate in the aqueous solution.

In some implementations, at least a portion of the at least one surface of the substrate may be flat.

In certain implementations, at least one portion of the at least one surface of the substrate may be three-dimensional. As an example, the at least one portion of the surface of the substrate may include a mesh, define perforations, or a combination thereof.

In some implementations, at least along the surface, the substrate may be formed of nickel, steel, copper, or a combination thereof.

According to another aspect, an electrode for an oxygen evolution reaction (OER) may include a substrate including at least one surface, and a layer of nickel coated on the at least one surface of the substrate, the at least one surface of the substrate has a first surface area, the layer of nickel has a second surface area, and a ratio of the second surface area to the first surface area is greater than about 10:1 and less than about 50:1.

In certain implementations, the substrate may be formed of nickel, steel, copper, or a combination thereof.

In some implementations, at least a portion of the at least one surface of the substrate may be three-dimensional. As an example, at least one portion of the at least one surface of the substrate may be a mesh and/or may define perforations.

In certain implementations, the layer of nickel may define a plurality of pores. For example, at least a subset of the plurality of pores may have a size greater than about 1 micron and less than about 100 microns. Additionally, or alternatively, average pore size of the plurality of pores may be greater than 20 microns and less than 40 microns.

According to yet another aspect, a battery may include comprising the electrode according to any of the aspects described herein.

### DESCRIPTION OF THE DRAWINGS

FIG. 1A is a schematic representation of an electrochemical cell.

FIG. 1B is a schematic representation of a rechargeable battery.

FIG. 2A is a schematic representation of a cross-sectional view of an electrode including a substrate and a layer of nickel coated on at least one surface of the substrate.

FIG. 2B is a micrograph of a nickel-coated surface of the oxygen evolution electrode represented schematically in FIG. 2A, the surface shown at 300× magnification.

FIG. 2C is a micrograph of the surface of FIG. 2B, shown at 400× magnification.

FIG. 3 is a micrograph of a commercially electroplated nickel surface, the surface shown at 500× magnification.

FIG. 4A is a flow chart of an exemplary method of making an oxygen evolution electrode for a metal-air battery.

FIG. 4B is a schematic representation a system for forming an oxygen evolution electrode according to the exemplary method of FIG. 4A.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Unless otherwise specified or made clear from the context, all references to mean particle size herein shall be understood to refer to mean particle size on a weight percentage basis. Thus, some references to mean particle size herein may occasionally omit specific mention of “weight percentage basis” for the sake of clarity and readability.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

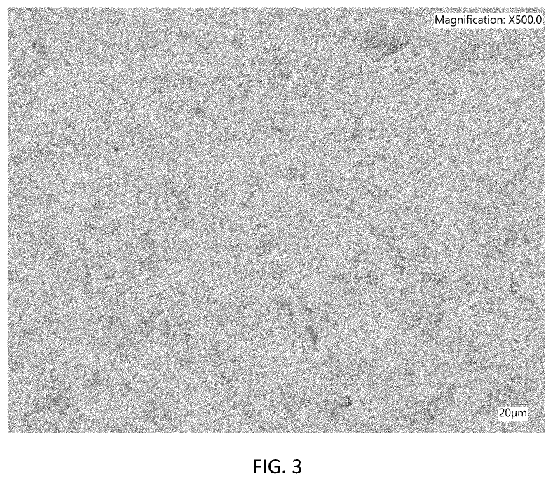

As used herein, the term “commercially electroplated nickel surface” or grammatical variants thereof shall be understood to refer to a smooth nickel surface, an example of which is shown in FIG. 3, formed by electroplating nickel onto a metal substrate by immersing the metal substrate into an electrolyte solution and applying an electric current such that the metal substrate acts as a cathode and a nickel anode dissolves to form nickel ions that ultimately become electrodeposited as a smooth layer on the metal substrate. In this context, smoothness of commercially electroplated nickel surfaces shall be understood to refer to electroplated nickel surfaces that have roughness average (Ra) values from 0.1 microns to 2 microns. Electroplated nickel surfaces with these Ra values may appear smooth bright, in contrast to the rough and dull appearance of the nickel coatings described herein. In this context, Ra values shall be understood to refer to values determined according to American Society of Mechanical Engineers (ASME) Standard B46.1—Surface Texture (Surface Roughness, Waviness, and Lay) (2019), the entire contents of which are incorporated herein by reference. In the description that follows, Ra values from 0.1 microns to 2 microns corresponding to commercially electroplated nickel surfaces shall be understood to have a ratio of coating surface area to substrate surface area less than 10:1 (e.g., less than 3:1).

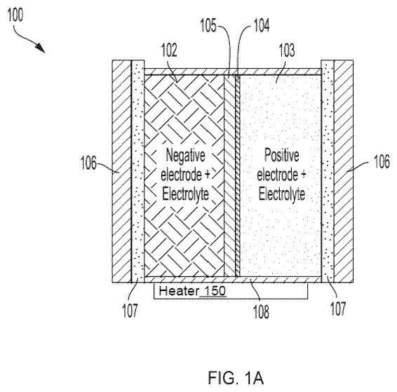

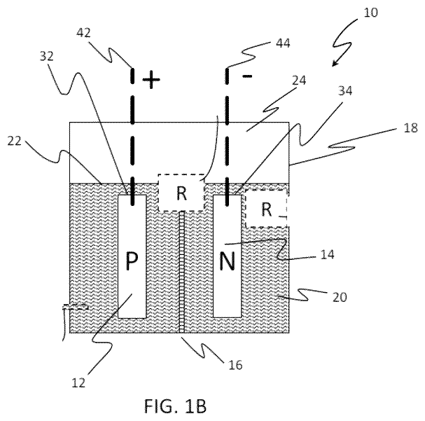

Referring now to FIG. 1A, an electrochemical cell 100 (e.g., a battery) may include a negative electrode 102 separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and positive electrode 103 and supported by backing plates 106 (e.g., polyethylene or polypropylene backing plates). In some embodiments, the temperature of the electrochemical cell 100, may be controlled, such as by insulation around the electrochemical cell 100 and/or by a heater 150. For example, the heater 150 may raise the temperature of the electrochemical cell 100 and/or specific components of the cell, such as an electrolyte infiltrated in the negative electrode 102 and the positive electrode 103. The electrolyte may be an aqueous solution. In certain embodiments the electrolyte may be an alkaline solution (pH>10). In certain embodiments, the electrolyte may be a near-neutral solution (10>pH>4).

The electrochemical cell 100 is merely an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

Referring now to FIG. 1B, a rechargeable battery 10 may include a positive electrode 12, a negative electrode 14, and a separator 16 within a container 18 filled with electrolyte 20 to a level 22 at least as high as the respective tops 32, 34 of the electrodes 12, 14. The space above the level 22 of the electrolyte 20 may be referred to as the headspace 24. The positive electrode 12 may be electrically connected to a positive terminal 42 of the rechargeable battery 10 and may contain active material that may undergo reduction reactions during discharging and oxidation reactions during charging. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 in FIG. 1B is merely an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a battery 10 may include a separator 16 that allows transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the container 18 may be made of any suitable materials and construction capable of containing the electrolyte, electrodes, and at least a minimum amount of gas pressure. For example, the container 18 may be made of metals, plastics, composite materials, or others. In some embodiments, the battery container 18 may be sealed so as to prevent the escape of any gases generated during operation of the battery.

In some embodiments, the battery container 18 may include a pressure relief valve to allow release of gases when a gas pressure within the battery container 18 exceeds a pre-determined threshold.

While the electrodes 12, 14 are shown substantially spaced apart in the figures, in some embodiments the electrodes may be very close to one another or even compressed against one another with a separator 16 in between. Furthermore, although the figures may illustrate a single positive electrode 12 and a single negative electrode 14, battery systems within the scope of the present disclosure may also include two or more positive electrodes 12 and/or two or more negative electrodes 14.

Referring now to FIGS. 1A and 1B, it shall be generally understood that the negative electrode 102 of the electrochemical cell 100 and/or the negative electrode 14 of the rechargeable battery 10 may include metal or metal oxides such as iron, zinc, cadmium, or other metals and/or oxides or hydroxides of these or other metals, unless otherwise specified or made clear from the context. Further, it shall be generally understood that the negative electrode 102 of the electrochemical cell 100 and the negative electrode 14 of the rechargeable battery 10 have similar or identical features, unless otherwise indicated or made clear from the context and, for the sake of efficient description, these are not described separately for each negative electrode. Thus, in view of the foregoing, embodiments in the description that follows are described in the context of the negative electrode 14 and, more specifically, in the context of the negative electrode 14 as an iron negative electrode. Accordingly, the negative electrode 14 shall be referred to hereinafter as “the iron negative electrode 14” and all such references shall be understood to be intended to encompass references to other types of active metals described herein and to other negative electrodes described herein (e.g., to the negative electrode 102), unless otherwise specified or made clear from the context.

Having described certain aspects of the electrochemical cell 100 and the battery 10, attention is now directed to the description of certain aspects of the positive electrode 103 and the positive electrode 12. For example, the positive electrode 103 and/or the positive electrode 12 may be an oxygen evolution electrode (OEEs) (also sometimes referred to as oxygen evolution reaction (OER) electrode). An OEE produces oxygen (O₂) gas via electrolysis.

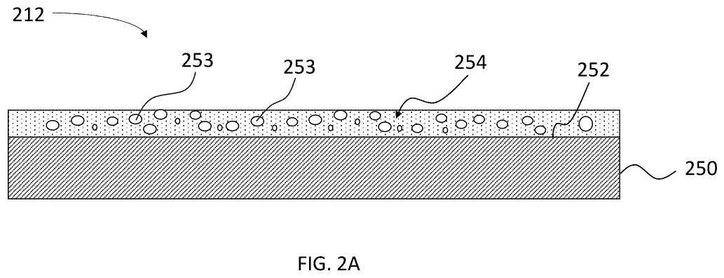

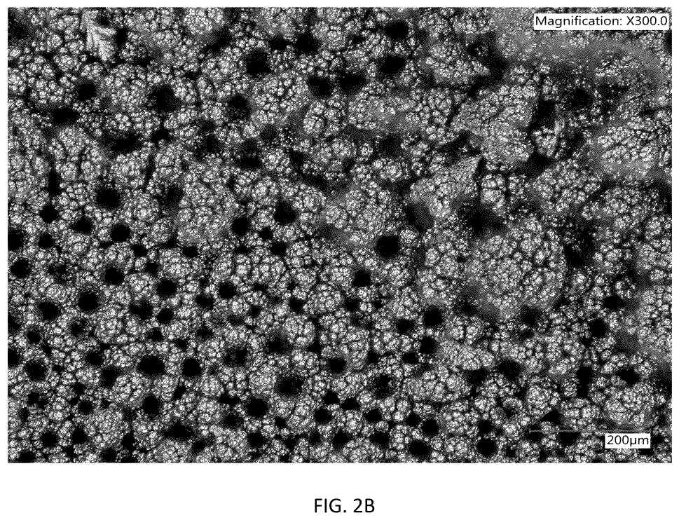

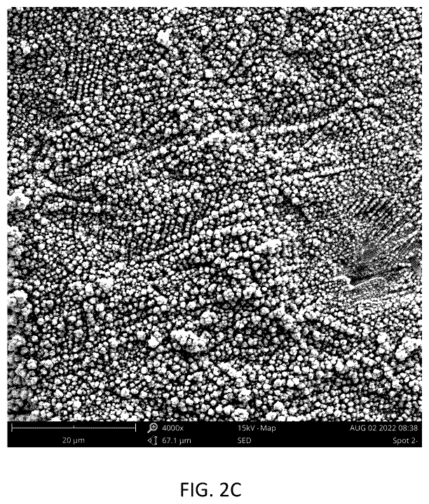

Referring now to FIGS. 2A-2C, an electrode 212 for an oxygen evolution reaction in the rechargeable battery 10 (FIG. 1A) and/or in the electrochemical cell 100 (FIG. 1B) may include a substrate 250 and a layer 254 of nickel coated on at least one surface 252 of the substrate 250. The at least one surface 252 of the substrate 250 may have a first surface area, and the layer 254 of nickel may have a second surface area greater than the first surface area. The ratio of the second surface area of the layer 254 of nickel to the first surface area of the at least one surface 252 of the substrate 250 is a quantitative parameter indicative of roughness of the layer 254 of nickel relative to roughness of the at least one surface 252 of the substrate 250. Stated differently, the layer 254 of nickel may be rough relative to the at least one surface 252 of the substrate 250 such that the ratio of the second surface area to the first surface area is greater than 1:1, with increasing ratios corresponding to a rougher instances of the layer 254 for a given instance of the at least one surface 252 of the substrate 250.

In use, as compared to smoother layers of nickel formed using commercial nickel electroplating (such as the commercially electroplated nickel surface shown in FIG. 3), additional surface area of the layer 254 of nickel compared to the surface area of at least one surface 252 upon which the layer 254 is coated may increase the effectiveness of the nickel in the coating. For example, in certain instances, the additional surface area of the layer 254 of nickel compared to the surface area of the at least one surface 252 upon which the layer 254 is coated may increase the probability of the oxygen evolution reaction taking place and, thus, decrease overpotential required for operation of an electrochemical cell (e.g., the electrochemical cell 100 in FIG. 1A or the rechargeable battery 10 in FIG. 1B) as compared to the overpotential required for operation of an electrochemical cell including an electrode with less surface area of nickel and, thus, lower probability of the oxygen evolution reaction taking place.

Competing considerations of manufacturing cost and electrochemical performance are effectively balanced at a ratio of the second surface area of layer 254 of nickel to the first surface area of the at least one surface 252 of the substrate 250 greater than about 10:1 and less than about 50:1 (with approximations at each end of the range intended to account for manufacturing tolerances). Specifically, ratios below 10:1 do not demonstrate significant performance improvement relative to the degenerate case of a commercially nickel electroplated surface. Further, or instead, ratios greater than 50:1 increase cost-namely, materials cost and capital equipment cost required for handling high-current density associated with the techniques described herein-without corresponding gains in improvement in performance relative to ratios greater than about 10:1 and less than about 50:1.

In instances of the electrode 212 having a ratio of the second surface area of layer 254 of nickel to the first surface area of the at least one surface 252 of the substrate 250 in the range of greater than about 10:1 and less than about 50:1, the layer 254 of nickel may define a plurality of pores 253 such that the structure of the layer 254 of nickel is cauliflower-like, including micron-sized nodules making up a larger porous framework (as shown in FIGS. 2B and 2B). At least a subset of the plurality of pores 253 may have a size greater than about 1 micron and less than about 100 microns. Further, or instead, average pore size of the plurality of pores 253 may be greater than 20 microns and less than 40 microns (e.g., 30 microns) As described in greater detail below, this structure may be formed by generating hydrogen bubbles on the at least one surface 252 of the substrate 250 while plating the layer 254 of nickel. This may, in some instances, result in the layer 254 of nickel being black in color. Further, or instead, the plurality of pores 253 of the layer 254 of nickel with pore sizes around 30 microns and below.

In general, the substrate 250 may be formed of any one or more materials upon which nickel may be electroplated and, further or instead, may be in any one or more shapes of the electrode 212 corresponding to end-use in a particular configuration of an electrochemical cell (e.g., the electrochemical cell 100 in FIG. 1A or the rechargeable battery 10 in FIG. 1B). Thus, in certain instances, the substrate 250 may be shaped such that at least a portion of the at least one surface 252 is flat. Further, or instead, the substrate 250 may be shaped such that at least a portion of the at least one surface 252 is three-dimensional (e.g., a mesh and/or curved). Additionally, or alternatively, the substrate may be formed steel, copper, or a combination thereof. As compared, for example, to oxygen evolution electrodes made from bulk nickel expanded and woven meshes, the additional surface area of the layer 254 of nickel may be cost-effectively achieved, particularly in instances in which the substrate is formed of a material less expensive than nickel.

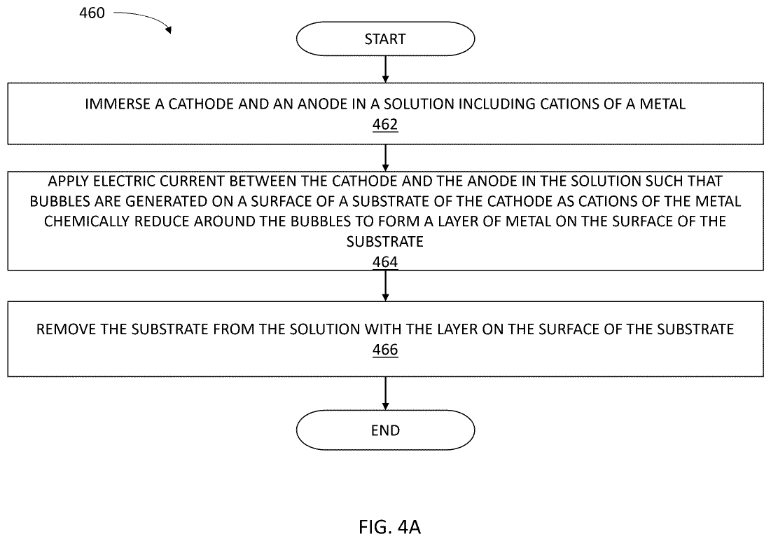

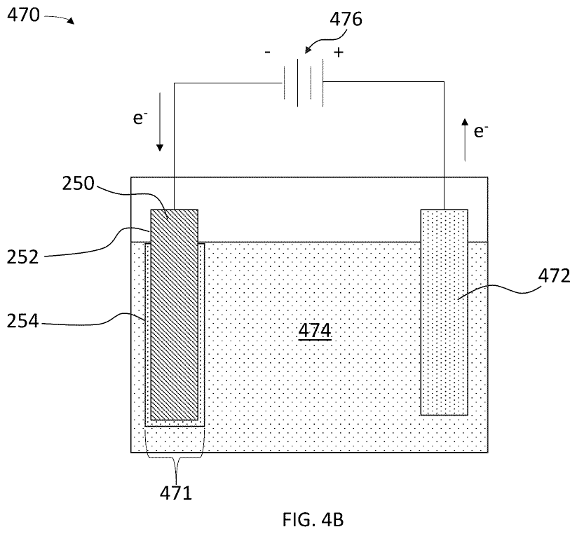

FIG. 4A is a flow chart of an exemplary method 460 of making an oxygen evolution electrode for a metal-air battery. Referring now to FIGS. 4A and 4B, unless otherwise specified or made clear from the context, the exemplary method 460 may be carried out using a plating system 470 to make any one or more of the electrodes described herein. Further, or instead, unless otherwise specified or made clear from the context, the exemplary method 460 may be carried out using the plating system 470 to form the layer 254 of any metal compatible with the chemistry of the plating system 470. For example, the exemplary method 460 may be carried out using the plating system 470 to make the electrode 212 (FIG. 2A) in which the layer 254 is nickel. As compared to other approaches of forming metal with a high surface area, the exemplary method 460 may be used to form the high surface area coating cost-effectively and with relatively inexpensive equipment. For example, as compared to using multiple coating processes to achieve a thick and cohesive layer of metal on a substrate, the exemplary method 460 facilitates forming a high-surface area layer of metal using only a single process to generate a layer of metal having three-dimensional surface area and robust cohesion for sustained performance in an electrochemical cell. Further, or instead, the plating system 470 may be operated at high current density to carry out the exemplary method 460, which may require less time and less expensive equipment than may otherwise be required for producing a layer of electrochemically active material (e.g., nickel) using multiple coating steps.

As shown in step 462, the exemplary method 460 may include at least partially immersing a cathode 471 and an anode 472 in a solution 474. The solution 474 may include cations of a metal (e.g., nickel), and the cathode 471 may include the substrate 250 to be coated. For example, the solution 474 may include ammonium cations. Continuing with this example, the cations of the metal may correspond to cations of any metal compatible with ammonium cations in the solution 474. As described above, the substrate 250 may be any one or more of various different shapes, sizes, and/or materials useful for cost-effectively accommodating a particular end-use. Thus, in some instances, at least a portion of the at least one surface 252 of the substrate 250 may be flat. Additionally, or alternatively, at least a portion of the at least one surface 252 of the substrate 250 may be three-dimensional. For example, the at least one portion of the at least one surface 252 of the substrate may include a mesh, define perforations, or a combination thereof. Further, or instead, at least along the at least one surface 252 of the substrate 250, the substrate 250 may be formed of nickel, steel, copper, or a combination thereof.

In certain implementations, the solution 474 may be aqueous such that the bubbles generated on the at least one surface 252 of the substrate 250, as described in greater detail below, are hydrogen. For example, at least partially immersing the cathode 471 and the anode 472 in the solution 474 in step 462 may include dissolving a metal salt in water. As a specific example, the metal salt may include a nickel salt such that the layer 254 formed on the at least one surface 252 of the substrate 250 of the cathode 471 includes nickel. In some instances, the nickel salt may include nickel chloride. Additionally, or alternatively, at least partially immersing the cathode 471 and the anode 472 in the solution 474 may include dissolving ammonium chloride in the solution 474 in instances in which the solution 474 is an aqueous solution. Dissolving ammonium chloride in the solution 474 in such instances may be useful for balancing competing considerations associated with using current to achieve rapid plating of the metal while also current to achieve robust formation of bubbles (hydrogen bubbles in the case of ammonium chloride in an aqueous solution). That is, although the addition of ammonium chloride to the solution 474 in instances in which the solution is aqueous decreases the concentration of the metal cations in the solution 474, the reaction of the ammonium cations favors hydrogen generation such that current may be used efficiently to achieving rapid plating around a significant concentration of bubbles on the at least one surface 252 of the substrate 250, as described in greater detail below. While the use of ammonium chloride in the solution 274 has been described as being useful for achieving balance between plating and bubble generation, it shall be appreciated that dissolving other material (e.g., ammonium sulfamate) that forms ammonium cations in the aqueous solution may be additionally or alternatively used to achieve such a balance.

As shown in step 464, the exemplary method 460 may include applying electric current between the cathode 471 and the anode 472 in the solution 474. For example, the electric current may be applied between the substrate 250 and the anode 472 using a power supply 476. The electric current may generate bubbles on the at least one surface 252 of the substrate 250 of the cathode 471 as the cations of the metal chemically reduce around the bubbles on the at least one surface 252 of the substrate 250 and form the layer 254 of the metal on the at least one surface 252 of the substrate 250. That is, the bubbles on the at least one surface 252 of the substrate 250 form a scaffold around which the cations of the metal in the solution 474 chemically reduce to form the layer with a rough texture that corresponds to high surface area of the metal in the layer.

As shown in step 466, the exemplary method 460 may include, with the layer formed on the surface of the substrate, removing the substrate from the solution.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. A method of making an oxygen evolution electrode for a metal-air battery, the method comprising:
at least partially immersing a cathode and an anode in a solution, the solution including cations of a metal;
applying electric current between the cathode and the anode in the solution, the electric current generating bubbles on at least one surface of a substrate of the cathode as the cations of the metal chemically reduce around the bubbles on the at least one surface of the substrate and form a layer of the metal on the at least one surface of the substrate; and
with the layer formed on the surface of the substrate, removing the substrate from the solution.

2. The method of claim 1, wherein the solution further includes ammonium cations.

3. The method of claim 1, herein the solution is an aqueous solution, and the bubbles on the at least one surface of the substrate are hydrogen.

4. The method of claim 3, wherein at least partially immersing the cathode and the anode in the solution includes dissolving a metal salt in water.

5. The method of claim 4, wherein the metal salt includes a nickel salt, and the layer formed on the at least one surface of the substrate of the cathode includes nickel.

6. The method of claim 5, wherein the nickel salt includes nickel chloride.

7. The method of claim 3, wherein at least partially immersing the cathode and the anode in the solution includes dissolving ammonium chloride in the aqueous solution.

8. The method of claim 3, wherein at least partially immersing the cathode and the anode in the solution includes dissolving ammonium sulfamate in the aqueous solution.

9. The method of claim 1, wherein at least a portion of the at least one surface of the substrate is flat.

10. The method of claim 1, wherein at least one portion of the at least one surface of the substrate is three-dimensional.

11. The method of claim 10, wherein the at least one portion of the surface of the substrate includes a mesh, defines perforations, or a combination thereof.

12. The method of claim 1, wherein, at least along the surface, the substrate is formed of nickel, steel, copper, or a combination thereof.

13. An electrode for an oxygen evolution reaction (OER), the electrode comprising:
a substrate including at least one surface; and
a layer of nickel coated on the at least one surface of the substrate, the at least one surface of the substrate has a first surface area, the layer of nickel has a second surface area, and a ratio of the second surface area to the first surface area is greater than about 10:1 and less than about 50:1.

14. The electrode of claim 13, wherein the substrate is formed of nickel, steel, copper, or a combination thereof.

15. The electrode of claim 13, wherein at least a portion of the at least one surface of the substrate is three-dimensional.

16. The electrode of claim 15, wherein at least one portion of the at least one surface of the substrate is a mesh.

17. The electrode of claim 13, wherein the layer of nickel defines a plurality of pores.

18. The electrode of claim 17, wherein at least a subset of the plurality of pores has a size of greater than about 1 micron and less than about 100 microns.

19. The electrode of claim 18, wherein average pore size of the plurality of pores is greater than 20 microns and less than 40 microns.

20. A battery comprising the electrode of claim 13.
